(19) United States
(12) Patent Application Publication
(10) Pub. No.: US 2014/0067619 A1
(43) Pub. Date: Mar. 6, 2014

(54) Product Catalog, Method For Ordering Products Presented In A Product Catalog And Computer Program Product Therefor

(71) Applicant: CADENAS GmbH, Augsburg (DE)

(72) Inventor: Juergen HEIMBACH, Augsburg (DE)

(73) Assignee: CADENAS GmbH, Augsburg (DE)

(21) Appl. No.: 14/018,498

(22) Filed: Sep. 5, 2013

(30) Foreign Application Priority Data
Sep. 5, 2012 (DE) 102012108223.5
Jan. 8, 2013 (EP) 13150452.4

(51) Int. Cl. G06Q 30/06; G06K 19/06

(52) U.S. Cl. CPC G06Q 30/0635; G06K 19/06037
USPC 705/26.81; 235/494; 235/375

(57) ABSTRACT

A product catalog with a collection of information about products with the presentation of the information including, at least for certain products contained in the catalog, a machine-readable product code, which contains information about the product. To make it as easy as possible for the user to order products presented in the catalog in an automated manner that saves times and has low susceptibility to error, at least one identification means with individual data of a user of the product catalog for identifying the user is arranged in or on the product catalog such that it can be read out together with at least one product code by a reading device. A method for automatic ordering by a user of products presented in a product catalog or of graphical or virtual representations of such products, and a computer program product for automated performance of the method is also described.

### CROSS REFERENCE TO RELATED APPLICATIONS

This application claims priority under 35 U.S.C. §119 to German Patent Application No. 10 2012 108 223.5 filed 5 Sep. 2012 and European Patent Application No. 13 150 452.4 filed 8 Jan. 2013, the entire contents of each are incorporated herein by reference.

### FIELD OF THE INVENTION

The invention pertains to a product catalog. The invention further pertains to a method for automatic ordering by a user of products presented in a product catalog and to a method for automatically ordering and transmitting graphical or virtual representations of components presented in a catalog. The invention also pertains to a computer program product for automated performance of these methods.

### BACKGROUND OF THE INVENTION

Methods for automated ordering of products displayed in product catalogs are known from prior art. Thus DE 10 2006 024 824 A1 shows a method for ordering a product from a mail-order distributor, wherein the orderer sends the mail-order distributor images of the products to be ordered and textual sender information that identifies him as the orderer. The images and sender information can be processed largely automatically by the mail-order retailer. For example, the mail order retailer can automatically compare the sender information against a customer database in order to identify the customer and the image transmitted by the customer can be compared against a product information database in order to identify the product ordered. The data from the customer and the images of the products to be ordered are sent via an electronic medium such as the Internet or a mobile telephone network. It is disadvantageous in this method that the customer must manually input the sender information together with the images of the selected products into an electronic message transmission system such as a system for sending e-mails. This is time-consuming and prone to errors.

A device and a method for handling orders from an order catalog are known from DE 299 12 233 U1, wherein machine-readable ordering data are assigned to the products shown in the catalog. The machine-readable data, for example, are contained in the form of a barcode in the order catalog and are assigned to the individual products. The machine-readable ordering data are read out with a suitable reading device and then submitted via a transmission unit to a remote computer. Data specific to the orderer (end-user) are also sent. Such data are stored in the transmission unit and contain, for example, the name and address of the orderer (customer) and are transmitted for each order to the remote computer together with the ordering data read out by means of the reading device. In order to simultaneously transmit the ordering data for the product to be ordered and the specific data for the orderer (customer), however, it is necessary to use the transmission device in which the customer-specific data are stored for every order and to couple this device with the reading device with which the machine-readable ordering data for the product to be ordered have been read. This requires a considerable expense for equipment.

### SUMMARY OF THE INVENTION

Starting from this point, one aspect of the invention addresses the problem of specifying a product catalog and methods for automatic ordering of products illustrated in the product catalog, with which a user can order the products illustrated in the product catalog in the simplest manner, which saves times and has low susceptibility to error. Another problem addressed by an aspect of the invention is to provide a computer product that enables an automated method for ordering products illustrated in the product catalog.

The product catalog according to the invention, which can be a printed or electronic product catalog, contains a collection of information about products (goods and/or services), wherein the representation of the information comprises, at least for some products contained in the product catalog, a machine-readable product code that contains information about the product (product information). The illustrations of all products listed in the product catalog expediently contain such a machine-readable product code. This is not absolutely necessary, however; i.e. some products to which no machine readable product code is assigned can be contained in the product catalog. The product information contained in the product code for the associated product can be, for example, a product name, an order or item number, the price, the delivery time or other product-specific information. The product code expediently contains information about the associated product such that an unambiguous identification of the product is enabled, possibly by access to a product information database stored by a supplier of the products from whom the product can be ordered. The product catalog according to an embodiment of the invention has at least one identification means with individual data about the user of the product catalog for identifying the user is arranged in or on the product catalog. The identification means contains individual data for the user of the product catalog (user information), which expediently enables an unambiguous identification of the user. The identification means can be, for example, a machine-readable user code or a business card of the user. The identification means, i.e. the machine-readable user code or the business card, for example, is arranged in relation to the product code contained in the product catalog in such a manner that the identification means together with at least one product code can be read by a suitable reading device. The user information contained in the identification means can be the name and address of the user, for example. It is particularly expedient if an e-mail address of the user is contained in the identification means. The identification means can also contain (only) an e-mail address of the user or a customer number or other information that allows an unambiguous identification of the user, possibly by access to a database stored by the user by which the product to be ordered can be ordered. Further user-specific data that can be contained in the identification means can be a billing address, bank information for collecting the purchase price for the ordered product or corresponding credit card data for that purpose, specific ordering conditions such as discounts, bonus data or the like, for example. The identification means can additionally comprise configuration data for the user's IT environment, such as configuration data regarding data processing programs with which the user works. The user information contained in the identification means can be contained in text form or in the form of a machine-readable code such as a one-dimensional or two-dimensional barcode, particularly in the form of a QR code.

By arranging the identification means in or on the product catalog in such a manner that it can be read together with at least one product code in the product catalog by a reading device, the product catalog according to an embodiment of the invention allows an efficient and simultaneous acquisition of the data regarding the products being ordered (product information) and the user (user information) placing the order. To place an order, the user need only initially select a desired product in the product catalog and open the catalog page in which the selected product is illustrated together with the assigned product code. The user can then preferably read out the product code of the selected product together with the identification means and simultaneously with a suitable reading device. Simultaneous is understood to mean that the identification means and the product code are read in a single scanning process in which the data for the identification means and the product are read and then decoded. The reading device is preferably designed such that it can simultaneously read the machine-readable product code and the identification means and then decode them and/or convert them into an electronic data format. If the identification means is a business card, for example, which contains the user data in text form, the reading device is designed to read the information contained in or on the identification means and for text recognition (“Optical Character Recognition,” OCR) and conversion of the acquired text into an electronic text format. The reading device is expediently coupled to a data processing device that processes the read data from the product code and the identification means and in particular decodes them and converts them into an electronic data format in order to generate an order therefrom that contains the data of the product code (product information) and of the identification means (user information). This order, which expediently is transmitted by means of a data connection to a provider of the selected product, thereby contains all data necessary for the order, particularly the identification of the ordered product and the user who is ordering the product.

In a preferred embodiment of the invention, both the product code and the identification means are a machine-readable code, in particular a QR code. The identification means in this case comprises a machine readable user code that contains the data for identifying the user in an encrypted form.

One aspect of the invention, which is used independently of the other aspects and to that extent is considered an invention in its own right, therefore also pertains to a method for simultaneously reading and processing machine-readable codes, in particular barcodes or QR codes and/or a code and a text, wherein at least two machine-readable codes arranged one next to another, or a machine-readable code and a text, are simultaneously read in a first step, i.e. in a reading step or a scanning process by means of a reading device, and the read-out data of the codes or of the code and the text is decoded and further processed in a second step by means of a data processing device. For an application of such a method for simultaneous reading and processing of machine-readable codes and optionally a text in the methods according to the invention for automatic generation of an order, it is provided that the read-out data of the codes and/or text are linked or combined with one another during processing in order to generate a combined data record. This method for reading and processing machine-readable codes or a code and a text can be used in the method according to the invention for automatic generation of an order by simultaneously reading out the product code and the user code or the product code and the identification means in text form and then linking the read-out and decoded data of the two codes to generate an order data record that contains the data for the product code and the user code or the identification means.

The product code and optionally the machine-readable user code can be a (one-dimensional) barcode or a two-dimensional code and in particular, QR codes including design QR codes, micro QR codes, secure QR codes (SQRC) or iQR codes. Other types of machine-readable codes can also be applied, such as data matrix codes colored codes such as “High-Capacity Color Barcodes (HCCB)” or “touch codes” as known for example from DE 20 2010 011 032 U1.

In a preferred embodiment, the product catalog is a printed product in the form of a printed catalog, a product brochure, a product flyer or the like. The identification means is expediently applied, more particularly printed, on a foldable flap that is arranged in or on the printed product (printed product catalog) in such a manner that, with the flap folded out, the user code can be read out by means of a reading device together with at least one product code that is assigned in the product catalog to a product contained therein and is printed there. In an especially expedient embodiment, the printed product has a binding with a binding cover, and the foldable flap with the identification means applied is mounted on the binding cover, by gluing for example. It is especially advantageous if the foldable flap is movably mounted on the binding cover. By moving the flap, it is then possible to arrange the identification means applied or printed thereon in such a manner that it is positioned directly next to the product code of the selected product on an open page of the printed product (product catalog). This enables simultaneously reading out both the product code and the identification means arranged next to it in a single reading step (scanning process) by a suitable reading device. The movability of the flap with the applied or printed identification means can be enabled for example by a tab movably arranged on the binding, or by a pocket arranged on the binding cover of the printer product, in which the flap with the applied identification means is movably inserted. A magnetic mounting of the flap on the binding cover or fastening by means of Velcro is also possible.

The product catalog according an embodiment of the invention is suitable for ordering all types of products i.e. particularly goods or services that can be shown in conventional product catalogs, such as clothing articles, toys and sporting goods, vehicle parts and accessories, electrical products, tools, furniture and home furnishings, package tours, etc. The product catalog according to an embodiment of the invention is also particularly suitable for ordering and transmitting graphic or virtual representations and in particular CAD drawings of products illustrated in the product catalog. For the design of mechanical components or electronic circuits, computer-assisted design (CAD) methods are typically used, wherein two-dimensional or three-dimensional drawings of the components being used or virtual (electronic) representations of the components are used. To create mechanical designs or electronic circuits, a designer can select an actually available component from a product catalog and in order to prepare a CAD design, can order a CAD drawing of the selected component from the component supplier, so that he can incorporate this CAD drawing or virtual representation of the component into his CAD design. The product catalog according to an embodiment of the invention makes it possible, efficiently and by means of an automated method, to order graphical or virtual representations, particularly CAD drawings, of components illustrated in a product catalog from a component supplier and have them delivered to the user. As in the ordering of a product illustrated in the product catalog, the user selects a desired component that is illustrated in the catalog and to which a machine-readable product code is assigned. The user then opens the product catalog to the corresponding page in which the selected component and the associated product code are shown and reads by means of a suitable reading device both the product code of the selected component and his identification means preferably arranged next to it, expediently simultaneously, in order to generate an order of a graphical or virtual representation of the selected component. The order is expediently generated in an automated method and transmitted to the supplier, preferably in electronic form. The supplier then transmits the graphical virtual representation of the selected component to the user, expediently in an electronic manner via a data connection.

In this embodiment of a method according to the invention for automatic ordering and transmission of graphical or virtual representations of a selected product (component), it is particularly expedient if the identification means contains specific data on the IT environment of the user, e.g. the designation, version and configuration of a CAD program with which the user processes the CAD drawings. This user-specific data regarding the user's IT environment can then be used by the supplier to generate the graphical virtual representation (CAD drawing) of the selected component that was ordered by the user. The graphical or virtual representation of the selected component can then be prepared in such a manner that the user can employ the transmitted graphical or virtual representation of the component (CAD drawing) directly (without the need for a conversion to a different data format) and process it with the CAD program he uses. This represents a considerable simplification, because most available CAD programs have their own specific data format, which complicates data exchange between different CAD programs.

It is practical for the reading device, with which the product code of the selected product and the identification means of the user can be read, expediently at the same time, to be a manual reading device. In particular, the reading device can be a smart phone that is equipped for reading and recognizing machine-readable code such as bar codes or QR codes. The reading device is expediently also equipped so that it can recognize texts by means of a text recognition method such as OCR and convert them into an electronic text format. This guarantees that the reading device can read both the machine-readable product code and the information means in text form or also contained in a machine-readable code, preferably simultaneously, and can process the read data (electronically and automatically). Mobile telephones of the newest generation (smart phones) and so-called PDAs (“personal digital assistants”) frequently have an installed camera and software that allows reading and decoding machine-readable codes and recognizing texts. The reading device can also be a conventional barcode scanner, however, which is expediently connected to a computer in order to be able to process the data for the product code of the selected product and the identification means and generate an order therefrom. In any case, the reading device is expediently contained in a data processing device such as a smart phone or computer or is connected to such a data processing device, a computer program preferably being provided in the device that combines the read-out data for the product code and the identification means and generates an electronic order using these data, which is then transmitted via a data connection, particularly an Internet or mobile phone connection, to a provider of the selected product to which the read-in product code is assigned. An order arriving at the provider of the selected product can be further processed there in a conventional manner in order to bring about supplying of the ordered product to the user or—as already described above—to transmit a graphical or virtual representation of a selected component to the user.

The computer program running on a processor of the data processing device is designed according to one aspect of the invention such that it automatically initiates an ordering process, wherein at least one machine-readable product code that is assigned to a selected product shown in a product catalog and contains information about the product (product information) is initially read in a first step by means of a reading device together with an identification means that contains individual data of a user (user information), wherein the reading device is coupled to the data processing device on which the computer program is running. In a second step of the automated ordering method, an electronic order is then generated by the computer program by combining the read-out data of the program code for the selected product and the identification means. The order generated in this manner by the computer program is then expediently sent automatically by electronic means via a data connection to a supplier of the selected product.

In a modified embodiment, it is also possible to first input the read-out data of the product code and the identification means into an order form in order to generate an order, this input preferably taking place automatically by the computer program. The order form can then be printed out by the user and sent in a conventional manner, e.g. by mail or fax, to a supplier of the selected product. It is also possible, however, to transmit an order form generated in this manner automatically via a data connection, e.g. via computer fax or e-mail or SMS or MMS directly to the supplier, and expediently at the same time generate a printout of the order form in order to provide the user with documentation of the dispatched order.

### BRIEF DESCRIPTION OF THE DRAWINGS

These and further advantages of the invention follow from the embodiments of the invention described below with reference to the accompanying drawings. The drawings show:

FIG. 1: representation of a first embodiment of a product catalog according to the invention in the folded-open state;

FIG. 2: representation of the rear cover page of the product catalog from FIG. 1;

FIG. 3: schematic representation of a method according to the invention for automatic ordering of products represented in a product catalog;

FIG. 4: schematic representation of a method according to the invention for automatic ordering and transmission of CAD drawings of products represented in a product catalog;

FIG. 5: representation of a second embodiment of a product catalog according to the invention in the folded-open state.

### DETAILED DESCRIPTION OF THE INVENTION

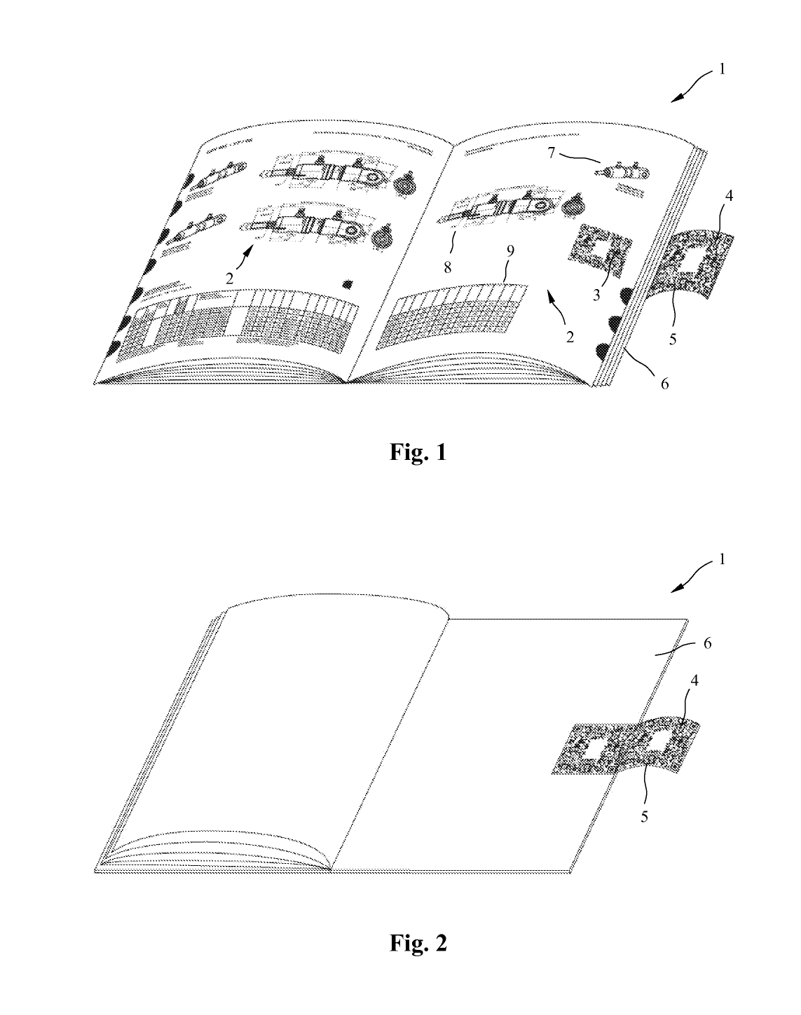

FIG. 1 shows a first embodiment of a product catalog according to the invention in a folded-open state. The product catalog 1, which is a printed product catalog in the embodiment shown, contains a collection of information about products, goods for example, particularly components, or services. The representation 2 of the information regarding the products is produced in the graphically illustrated example in the form of an image 7 of the product, a technical drawing 8 and/or textual information 9 about the product. The textual information is contained in a table in the embodiment shown and presents technical information about the illustrated product for example. The textual information could also be a textual description of the product or other product information such as an ordering or item number, the price, the delivery time, or delivery conditions or the like. In addition to this product information, machine-readable product codes 3 are presented in the product catalog 1, at least for some of the products contained therein. These product codes 3 assigned to the respective product can be constructed as one-dimensional barcodes or also as two-dimensional codes. The machine-readable code 3 is preferably a QR code. Information about the assigned product (product information) is contained in encoded form in the machine-readable product code 3. Machine-readable codes such as one-dimensional barcodes or two-dimensional QR codes are known from prior art and can be read out with a suitable reading device. The reading devices for reading out machine-readable codes comprise a device for scanning in the code and a data processing program for decoding the information contained in the code. The product code 3 contains, for example, information about the product assigned to it, which enables the identification of the product and optionally is already contained in the presentation 2, such as textual information 9 with an item or order number, a textual description of the product or technical drawings 8. In addition, further information about the product can also be contained in the product code 3. Each product code 3 particularly expediently contains an ordering or item number for the product assigned to it, which enables an unambiguous identification of the product.

An identification means in the form of a machine-readable user code 4 is also arranged in or on the product catalog 1. The machine-readable user code 4 can likewise be a one-dimensional barcode or a two-dimensional code. The machine-readable code 4 is preferably likewise implemented as a QR code. According to the invention, the machine-readable user code 4 is arranged in or on the product catalog 1 in such a manner that it can be read out together with at least one product code 3 by means of a suitable reading device 10. In an embodiment shown graphically in FIGS. 1 and 2, this is realized by printing the user code 4 onto a foldable flap 5, which is arranged in the product catalog 1 in such a manner that, with the flap 5 folded out, the user code 4 can be read by a suitable reading device 10 together with at least one product code 3 printed in the product catalog 1. The illustrated embodiment of a product catalog 1 according to the invention shows a product catalog 1 in book form with a binding (jacket) having a binding cover 6. The foldable flap 5 is shown in FIG. 2 on the inside of the rear binding cover 6. The foldable flap on the binding cover 6 can be fastened by gluing, for example. It is particularly expedient if the user code 4 is printed on a foldable flap 5 that is mounted in a corresponding manner on the inner side of the binding cover 6, as shown in FIG. 2. The foldable flap 5 can then be folded in when the product catalog 1 is not being used and is placed in a bookshelf for storage for example, so that the flap does not project laterally from the outer edge of the binding (jacket) of the product catalog 1. This prevents damage to the foldable flap 5 with the user code 4 printed thereon when the product catalog is not being used. For the intended use of the product catalog according to the invention, the foldable flap 5 can then be folded out as shown in FIG. 2. In this position of the foldable flap 5, the user code 4 printed thereon is visible with the product catalog open, as can be seen in FIG. 1. The user code can alternatively also be arranged in a tab, which is expediently movably arranged on the binding cover or a catalog page of the product catalog.

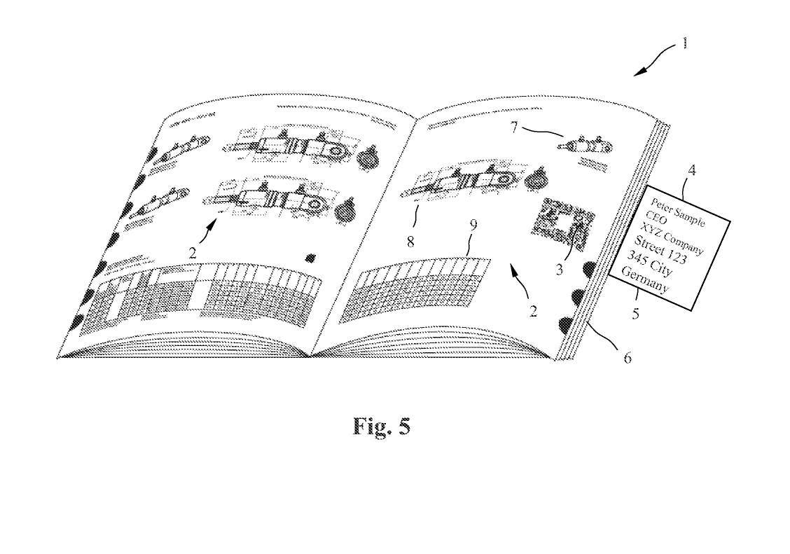

FIG. 5 shows a second embodiment of a product catalog according to the invention in a folded-open state. In this embodiment, the identification means 4 is formed by a business card 4′, which contains user-specific information (user information) in text form for identifying the user. The data (user information) contained on the business card 4′ includes in particular the name of the user and optionally additional data such as his company, his address etc., which are normally found on business cards.

In both embodiments of the product catalog described above, the user identification means, i.e. the machine-readable user code 4 or the business card 4′, contain individual data (user information) either in encoded form or in text form for a user of the product catalog 1 that enables an identification of the user, e.g. the name and address data of the user or a customer number. Additional user-specific data can also be contained in the identification means, e.g. data for cashless payment such as account or credit card information. The individual data contained in the identification means, and particularly in the machine-readable user code 4, can also be configuration data regarding the data processing programs or the IT environment employed by the user. The user code 4 can also contain even more individual information associated with the specific user of the product catalog 1, such as special delivery or discount conditions or data about bonus programs.

A user of the product catalog 1 according to an embodiment of the invention can design his own individual product catalog 1 tailored to his usage by producing an identification means 4 assigned to him and arranging the identification means 4 in the product catalog 1 as described. For this purpose, the user generates an encoded and machine-readable user code 4 that contains his individual user information. Suitable software programs for generating such machine-readable codes with individual data are known from prior art and are available on the market. Alternatively, the user can also use a business card 4′ as identification means 4 and position it in the manner described above on or in the product catalog. If the individual user information of the user changes, for example if he has a new address or has received modified delivery or discount conditions, the user can also modify the identification means 4 assigned to him correspondingly and for example replace his previous user code 4 with a new, adjusted user code 4 by printing his new user code 4 on a foldable flap 5, for example, or placing it in a tab and arranging the tab in the above-described manner in the product catalog 1.

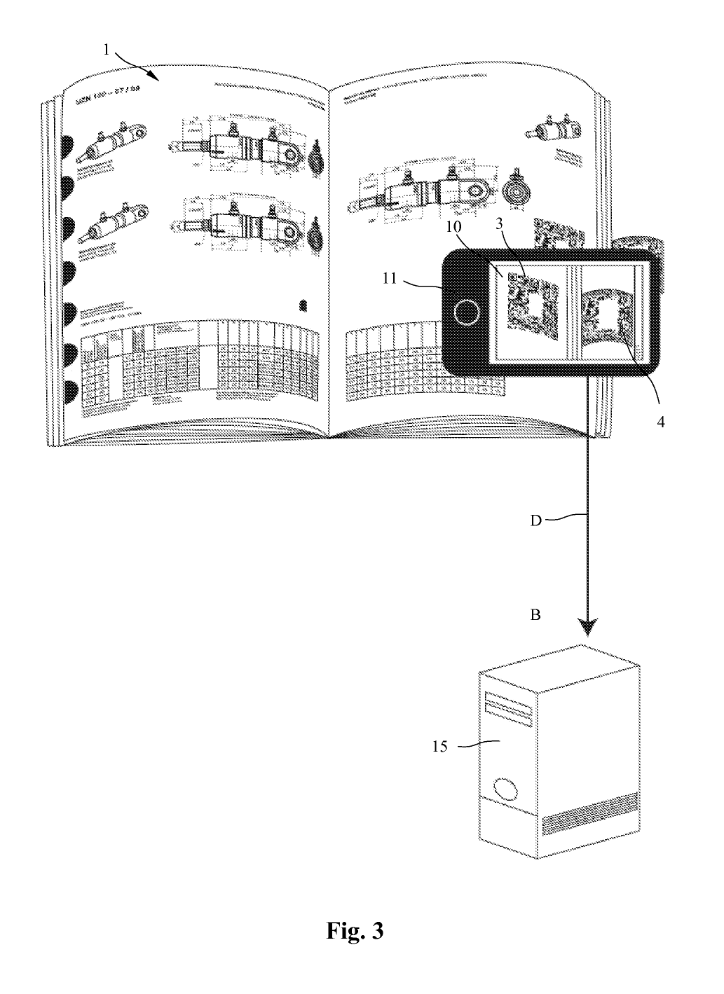

When the identification means 4 is arranged in the manner described and shown in FIGS. 1 and 5, the identification means 4 can be read out together with a product code 3 by means of a suitable reading device 10 and used for generating an order. To generate a user order for a product from a supplier who offers and can deliver the product, the user first selects the product to be supplied and opens the catalog page in which the selected product is presented in the product catalog 1. If the presentation 2 of the selected product contains a machine-readable product code 3, this product code 3 can be read out together with the user's identification means 4, if the identification means 4 is arranged as shown in FIGS. 1 and 5 for example (with a folded out flap 5 or a folded out business card 4′). For automated generation of an order, the user can then read out the product code 3 for the selected product and his individual identification means 4 by means of a suitable reading device 10, by pointing the camera or scanning device of the reading device 10 at the product code 3 of the selected product and the identification means 4 next to it and preferably simultaneously reading them out with the reading device 10, as shown in FIG. 3.

The reading device 10 is preferably a manual reading device. As a reading device 10, it is especially preferred to use a smart phone that has a camera for reading out machine-readable codes (barcodes or QR codes) and texts and can decode the read-out data of the code or the read-out text by means of a data processing program, decrypt it, convert it and optionally further process it. Such smart phones are available on the market. Alternatively, the reading device 10 can be a code scanner such as a barcode scanner that is connected to a data processing device 11, for example a computer. The data processing device 11 contains the computer program with which the read-out data of a machine-readable code can be decoded and with which read-out texts can be recognized with a text recognition software (OCR software) and optionally further processed.

The computer program running in the data processing device 11 or the smart phone on a processor in order to decode a machine-readable code decodes or recognizes the read-out data of the product code 3 for the selected product and individual identification means 4 and combines these data, which contain information about the selected product (product information) and individual information about the user (user information) of the product catalog, and generates an order therefrom. To generate the order, it can be provided in one variant embodiment that the read-out data of the product code 3 and the data for the individual identification means 4 are entered into an order form. The user can then print out the order form that has been automatically produced by the computer program and send it by mail or fax to a supplier of the selected product for example. It is advantageous, however, if the order form is generated in electronic form and transmitted by means of a data connection D, for example the Internet or a mobile phone connection, to a supplier of the selected product, as an e-mail, computer fax or as an SMS/MMS for example. The supplier can receive and process the electronic order B by means of a computer 15, for example (FIG. 3).

In all cases, the order arriving at the supplier of the selected product contains information about the selected and ordered product (product information) and about the user (user information) because the corresponding product and user information is contained on the one hand in the product code 3 of the selected product and on the other hand in the individual identification means 4 of the user (person ordering) and was imported into the order. Based on the order, the supplier of the selected product can transmit it to the user (person ordering).

The described method for automated ordering of products presented in the product catalog 1 is distinguished substantially by a simplification in the sense that the user no longer has to separately and laboriously enter individual user information and product information for the selected product when generating an order and submit an order form, but can instead import these data in a simple manner by reading in the product code of the selected product and his individual identification means automatically into an order. This method is distinguished by a low error rate, because the error rate when reading in machine-readable codes with suitable reading devices is very low. It is particularly expedient if the identification means, for example the user code 4, comprises data for a cashless payment of the selected and ordered product. Thereby the product can be paid for together with the ordering, for example by a debit order or by transmission of credit card data included in the individual user code 4.

The invention is not limited to the described embodiment of the product catalog 1. The product catalog 1 can be all possible forms of printed product catalogs. This includes, in particular, product catalogs in book form but also product catalogs in the form of brochures, flyers, prospectuses or the like. The invention is also not limited to usage of a printed product catalog. The invention can be applied in a corresponding manner with an electronic product catalog that can be displayed on a computer video screen for example. Here as well it is possible to display a user-specific user code 4 or electronic business card on the video screen in such a manner that it can be read out together with the product code 3 by a suitable reading device.

In a particularly expedient application case of the invention, graphical or virtual representations of components presented in a product catalog can be ordered in an automated process by a user and directly transmitted to the user. In this application case, the products illustrated in the product catalog 1 are technical components such as mechanical or electronic components. Graphical or virtual representations of such components are used in the form of CAD drawings in computer-assisted designing of products, for example. The computer-assisted designing of products is referred to as “CAD”. Graphical or virtual representations of components in the form of CAD drawings are used to create a virtual representation of the product to be constructed. In addition to the geometric dimensions and data of the components, CAD drawings also often contain additional information about the component, e.g. physical properties and material parameters such as mass, density, index of refraction, elastic properties, thermal and electrical properties and the like. Such CAD drawings therefore enable a virtual representation of the components and an end product composed of the components. There are a large number of specific software programs (CAD program) for producing such CAD drawings of components and products assembled therefrom, these software programs being capable of running on different computer operating systems and each using different system-specific data formats. Due to the system-induced differences between the software programs (CAD programs) tailored to different applications and between the different operating systems and system-specific data formats, a data conversion is often necessary if a CAD drawing for a component is to be used with a (different) CAD program for designing an end product that uses this component.

To design an end product, a designer orders CAD drawings of components from which the end product will be assembled from a supplier of the component. A product catalog 1 according to the invention can be used to simplify the ordering and transmission process and also to avoid data conversion of the CAD drawing of the components into another data format that is compatible with the CAD program of the user (orderer). For this purpose, the product code 3 of the component contained in the product catalog 1 contains information necessary for producing a CAD drawing for this component. In this application case, the individual identification means 4 for the user expediently contains, as an optional supplement to the information identifying the user, specific information about the user's IT environment, such as the operating system of the data processing device on which his CAD program runs, the program name and optionally the version of the CAD program he uses, and optionally additional specific configuration data regarding his data processing device and his CAD program. This user-specific information can also be stored in a database that is expediently stored with the supplier of CAD data for the selected component and can be read out from the database via the user information that is contained in the identification means 4 and unambiguously identifies the user.

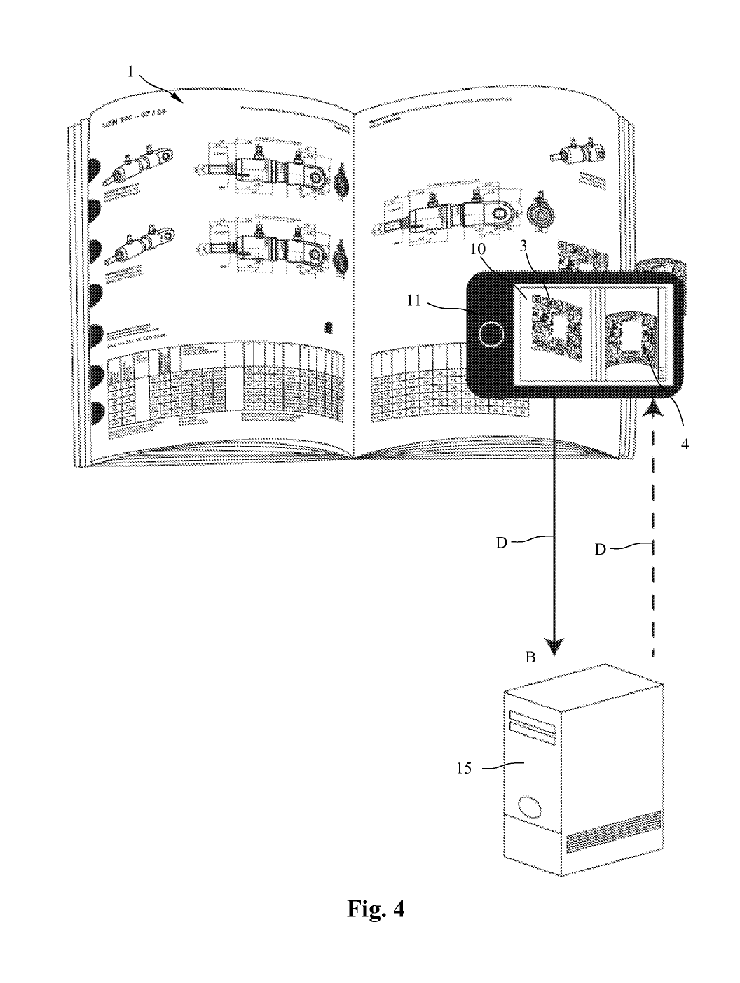

To generate an order B for a CAD drawing of a component he has selected, the user (designer) can then read, in the manner described above (preferably simultaneously), the product code 3 for the selected component and his individual identification means 4 by means of a suitable reading device 10, as shown in FIG. 4. The computer program in the reading device 10 or the data processing device 11 connected to the reading device 10 combines the read-out data of the product code 3 for the selected component and the individual identification means in order to generate an order B for a CAD drawing for the selected component, wherein the order B contains corresponding data of the product code 3 and the identification means 4. In particular, the order B contains an unambiguous identification of the ordered component (via an order or item number for example) and an identification of the user and in addition user-specific data regarding the CAD program employed by the user, with which the user would like to display the selected component and optionally process it further for designing an end product. The order B generated in this manner is expediently transmitted in electronic form by means of a data connection D to a supplier of the selected component (or a supplier of a CAD drawing for the selected component) (FIG. 4). Based on the data regarding the selected component and the user-specific data for the user (orderer) contained in the order B, the supplier can then generate a CAD drawing of the selected component tailored to the specific needs of the user (orderer), wherein the program information for the user and any versions and configurations of the CAD software contained in the identification means, i.e. in the specific user code, are expediently taken into account. The generated CAD drawing (CAD) of the selected component can then be sent to the user (orderer), preferably again in electronic form via a data connection D, as shown in FIG. 4. The user (orderer) is able to display the graphical or visual representation transmitted as a CAD drawing for the selected component directly, i.e. without data conversions, with his CAD program and further process it, because the transmitted CAD drawing is tailored specifically to the CAD program he uses and to his configuration.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. Product catalog, particularly in printed form, with a collection of information about products, wherein at least for individual products contained in the catalog, presentation of the information comprises a machine-readable product code, which contains information about the product, wherein at least one information means with individual data of a user of the product catalog for identifying the user is arranged in or on the product catalog such that the at least one information means can be read out together with at least one product code by a reading device.

2. Product catalog according to claim 1, wherein the product code is a barcode or a two-dimensional code, particularly a QR Code® and/or that the identification means is a machine-readable code, particularly a barcode or a QR Code®, or a user's business card.

3. Product code according to claim 1, wherein the identification means contains the user's name and address data, and in particular, the user's e-mail address.

4. Product catalog according to claim 1, wherein the identification means contains a customer number of the user and/or data for cashless payment and/or configuration data regarding data processing programs of the user, particularly CAD programs.

5. Product catalog according to claim 1, wherein the identification means is printed onto or fastened to a foldable flap that is arranged in the product catalog in such that the identification means can be read out by a reading device together with at least one product code when the flap is folded out.

6. Product catalog according to claim 5, wherein the product catalog has a binding with a binding cover and the foldable flap is mounted on the binding cover.

7. Product catalog according to claim 6, wherein the foldable flap is mounted displaceably on the binding cover.

8. Method for automatic ordering by a user of products presented in a product catalog, wherein a machine-readable product code is presented in the presentation of at least one of the products in the product catalog and contains information about the product, wherein the method includes the steps of:
providing a product catalog according to claim 1, which contains product codes for the products presented therein, and an identification means having individual user data for identifying the user,
reading out at least one product code assigned to a selected product and the identification means with a reading device that contains a data processing device or is coupled to a data processing device,
combining the read-out data from the product code or codes and the identification means by the data processing device for automatic generation of an order, which contains data from the product code and the data for identifying the user.

9. Method for automatic ordering and transmission of graphical or virtual representations, in particular CAD drawings, of components presented in a product catalog, wherein a machine-readable product code that contains information about the component is presented in the presentation of at least one of the components in the product catalog, wherein the method includes the steps of:
providing a product catalog according to claim 1, which contains product codes for the components presented therein, and an identification means having individual user data for identifying the user,
reading out at least one product code assigned to a selected component and the identification means with a reading device that contains a data processing device or is coupled to a data processing device,
combining the read-out data from the product code or codes and the user code by the data processing device for automatic generation of an order for a graphical or virtual representation of the component associated with the read-out product code, wherein the order contains data from the product code and the user code,
generating a graphical or virtual representation of the component associated with the read-out product code using the read-out data from the product code and the data for identifying the user,
transmitting the generated graphical or virtual representation of the selected component to the user.

10. Computer program product that, when executed by a processor in a data processing device, particularly a computer or a smartphone, causes the processor to automatically execute the following steps:
reading out at least one machine-readable product code, which is assigned to a selected product contained in a product catalog and contains information about the product, and an identification means with individual data of the user for identifying the user, with a reading device that is coupled to the data processing device,
combining the read-out data from the product code or codes and the data for identifying the user,
generating an order that contains data from the product code and data for identifying the user.

11. Method according to claim 8, wherein the read-out data from the product code and the data for identifying the user are provided by the data processing device in an order form in order to generate the order.

12. Method according to claim 8, further comprising the method step of transmitting the order and in particular the order form to a provider of the selected product or component to which the read-out product code is assigned.

13. Method according to claim 8, wherein the at least one product code and the identification means are read simultaneously, wherein the product code and the identification means are arranged adjacent to one another during the readout.

14. Method according to claim 8, wherein in the reading device is a manual reading device and in particular a smartphone that is equipped to read out and recognize barcodes and/or QR codes and/or for text recognition.

15. Method according to claim 8, wherein the data processing device is equipped with a computer program that combines the read-out data of the product code or codes and the identification means and generates an electronic order using these data when the computer program is executed on a processor of the data processing device, wherein the electronic order is transmitted via a data connection, in particular an Internet or mobile phone connection, to a provider of the selected product or component.

16. Method according to claim 9, wherein the data processing device is equipped with a computer program that combines the read-out data of the product code or codes and the identification means and generates an electronic order using these data when the computer program is executed on a processor of the data processing device, wherein the electronic order is transmitted via a data connection, in particular an Internet or mobile phone connection, to a provider of the selected product or component.

17. Method according to claim 9, wherein the read-out data from the product code and the data for identifying the user are provided by the data processing device in an order form in order to generate the order.

18. Method according to claim 9, further comprising the method step of transmitting the order and in particular the order form to a provider of the selected product or component to which the read-out product code is assigned.

19. Method according to claim 9, wherein the at least one product code and the identification means are read simultaneously, wherein the product code and the identification means are arranged adjacent to one another during the readout.

20. Method according to claim 9, wherein in the reading device is a manual reading device and in particular a smartphone that is equipped to read out and recognize barcodes and/or QR codes and/or for text recognition.

21. Computer program product according to claim 10, wherein the read-out data from the product code and the data for identifying the user are provided by the data processing device in an order form in order to generate the order.

22. Computer program product according to claim 10, further comprising the method step of transmitting the order and in particular the order form to a provider of the selected product or component to which the read-out product code is assigned.

23. Computer program product according to claim 10, wherein the at least one product code and the identification means are read simultaneously, wherein the product code and the identification means are arranged adjacent to one another during the readout.

24. Computer program product according to claim 10, wherein in the reading device is a manual reading device and in particular a smartphone that is equipped to read out and recognize barcodes and/or QR codes and/or for text recognition.
